(19) United States
(12) Patent Application Publication
(10) Pub. No.: US 2007/0251552 A1
(43) Pub. Date: Nov. 1, 2007

(54) Dish washer

(75) Inventor: Jhe Hyouk Lee, Gimhae-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/790,435

(22) Filed: Apr. 25, 2007

(30) Foreign Application Priority Data
Apr. 25, 2006 (KR) 10-2006-0037017

(51) Int. Cl. B08B 3/00

(52) U.S. Cl. 134/56 D

(57) ABSTRACT

A dishwasher is provided. The dishwasher includes a tub, a door, and a condenser. The tub forms a wash compartment within. The door selectively opens and closes the tub. The condenser suctions moist air from within the tub and air from outside the tub, mixes the suctioned air, and exhausts the mixed air to the outside.

The present application claims priority under 35 U.S.C. 119 and 35 U.S.C. 365 to Korean Patent Application No. 10-2006-0037017 (filed on Apr. 25, 2006), which is hereby incorporated by reference in its entirety.

### BACKGROUND

1. Field

This document relates to a dish washer.

2. Description of the Related Art

In general, a dishwasher includes a dish rack for holding dishes within a tub, a spray nozzle for spraying wash liquid onto dishes stored on the dish rack, a sump for providing wash liquid to the spray nozzles, a wash pump, and a wash motor.

In the above configured dishwasher, the wash pump operates to pump wash liquid stored in the sump through the spray nozzle. The wash liquid is sprayed at high pressure through the spray nozzle to collide with surfaces of dishes stored in the dish rack.

Thus, the water pressure of the wash liquid that collides with the surfaces of the dishes causes impurities on the surfaces of the dishes to be removed.

### SUMMARY

The implementation of the dish washer is provided. The dish washer includes a tub forming a wash compartment within; a door for selectively opening and closing the tub, and defining an indoor air inlet in a side thereof and a moist air inlet in an inner surface thereof; and a condenser provided within the door, for exhausting a mixture of indoor air and moist air suctioned into the door from the door, the moist air being from inside the tub.

### BRIEF DESCRIPTION OF THE DRAWINGS

FIG. 1 is a perspective view of a dishwasher;

FIG. 2 is a perspective view of a dishwasher with its door open;

FIG. 3 is a perspective view of a dishwasher with its door cover disassembled;

FIG. 4 is a frontal perspective view of a mixing device included in a condenser;

FIG. 5 is a rear perspective view of the mixing device in FIG. 4;

FIG. 6 is a sectional view of the mixing device in FIG. 4 taken along line I-I′;

FIG. 7 is a perspective view of an intake fan included in the mixing device in FIG. 4; and

FIG. 8 is a perspective view of an exhaust duct included in the condenser.

### DETAILED DESCRIPTION

Reference will now be made in detail to the preferred implementations of a dish washer, examples of which are illustrated in the accompanying drawings.

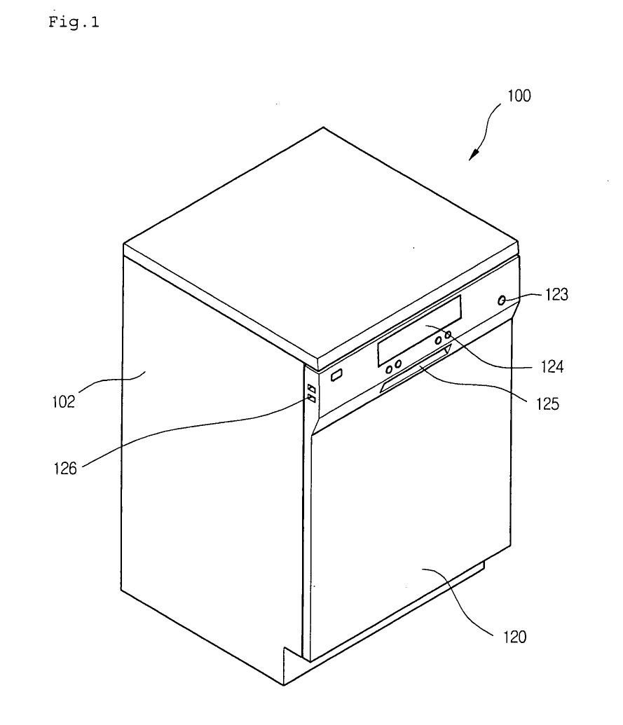

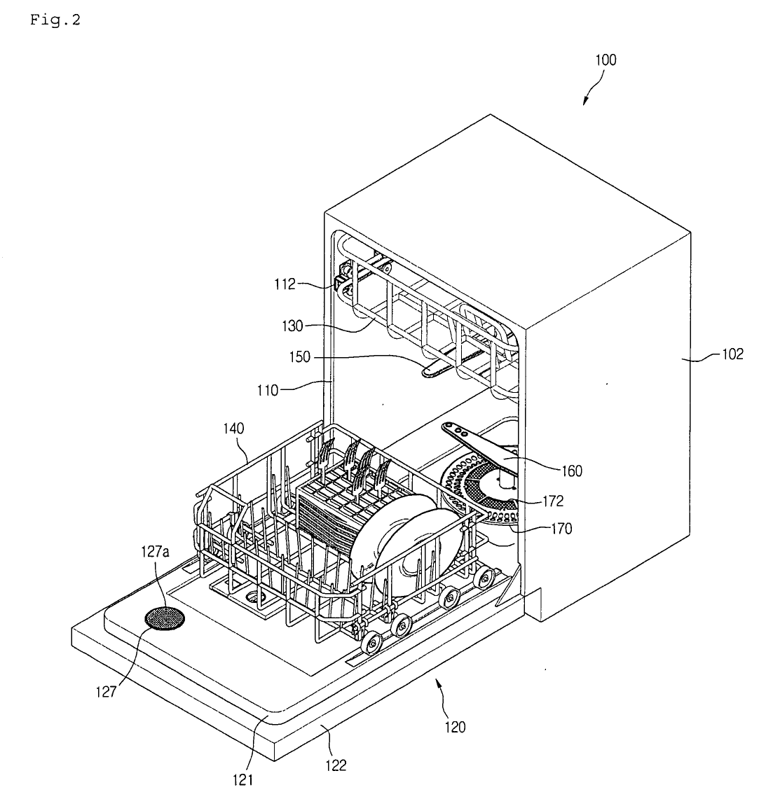

FIG. 1 is a perspective view of a dishwasher, and FIG. 2 is a perspective view of a dishwasher with its door open.

Referring to FIGS. 1 and 2, a dishwasher 100 includes a case 102 forming an outer shape of the dishwasher and an opening at a front thereof, a tub 110 provided inside the case 102 and forming a wash compartment within, a door 120 for selectively opening and closing the opening at the front of the tub 110, and a sump 170 provided at the bottom of the tub 110 to collect wash liquid and filter and re-circulate filtered wash liquid to be sprayed again.

In further detail, dishes are stored within the tub 110, an upper rack 130 and a lower rack 140 are provided to slide in and out of the tub 110, and an upper spray arm 150 and a lower spray arm 160 are provided to spray wash liquid toward the upper and lower racks 130 and 140.

Also, a rail 112 extends in a front-to-rear direction on the side surface of the tub 110 to support the sliding of the upper rack 130. A filter 172 is placed at the bottom of the tub 110 to filter impurities from wash liquid passing through the filter 172.

The door 120 includes a door liner 121 forming a detergent and rinse container within, and a door cover 122 coupled at the front surface of the door liner 121.

Additionally, the door 120 is coupled to the case 102 by means of a hinge (not shown) at the lower end of the door 120, so that the door 120 may be pivoted about the hinge in upward and downward directions by a user.

Specifically, the front surface of the door includes controls 123 that are used to turn the dishwasher 100 on and off, a display 124 for displaying the operating status of the dishwasher 100, and a handle 125 for opening and closing the door 120.

An indoor air inlet 126 is formed on the side of the door cover 122 to allow low temperature, dry air from the indoor space to enter during a drying cycle, and a moist air inlet 127 is formed in the door liner 121 for hot, moist air from within the tub 110 to enter through. A grill 127a in the shape of a net is provided on the moist air inlet 127.

Here, the indoor air inlet 126 may be formed on the side of the door cover 122 for aesthetic reasons; however, it is not restricted to any location, and may be formed on the front surface of the door cover 122, for example.

Also, a condenser (to be described below) is provided within the door 120 to mix moist air from inside the tub 110 and indoor air, and discharge the mixed air into the indoor space.

To describe the operation of the above-configured dishwasher 100, first, when a start button of the dishwasher 100 is pressed, wash liquid flows into the sump 170. Then, the wash liquid that flows into the sump 170 is pumped through a predetermined pumping action to the upper spray arm 150 and the lower spray arm 160. Here, the pumping is performed to alternately supply wash liquid to the upper spray arm 150 and the lower spray arm 160 at predetermined intervals.

Accordingly, within the tub 110, wash liquid is sprayed for a predetermined duration through the lower spray arm 160, and after the predetermined duration, wash liquid is sprayed through the upper spray arm 150, and the process is repeated to wash dishes.

When the wash cycle is completed, clean wash liquid is sprayed from the upper and lower spray arms 150 and 160 to rinse the dishes in a rinse cycle. When the rinse cycle is completed, a drying cycle is performed.

Here, heated wash liquid is used during the rinse cycle, and when the rinse cycle is completed, the air inside the tub 110 is hot and moist.

In detail, when the drying cycle is begun, the hot, moist air inside the tub 110 passes through the moist air inlet 127 into the door 120, and indoor air flows into the door 120 through the indoor air inlet 126.

Then, the moist air and indoor air that flows into the door 120 mixes in a condenser within the door 120. During the mixing process, condensed water flows into the tub 110, and the mixed air is exhausted into the indoor space through the bottom of the door 120.

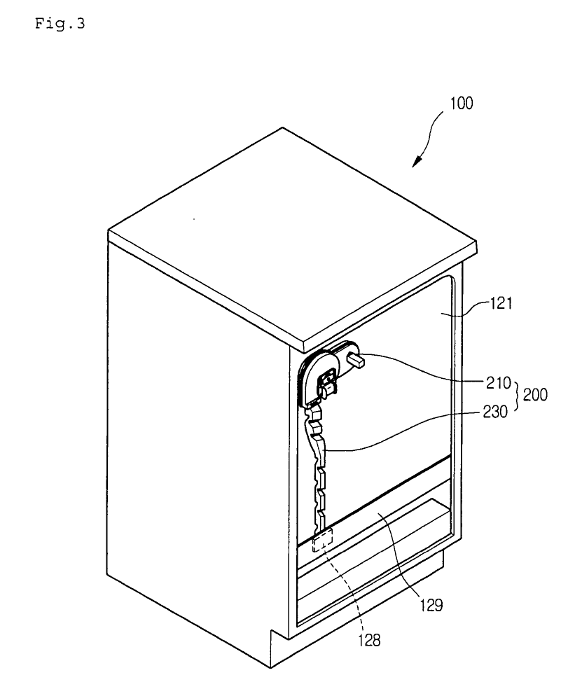

FIG. 3 is a perspective view of a dishwasher with its door cover disassembled.

Referring to FIG. 3, according to the present embodiment, a condenser 200 is provided in the door 120 of the dishwasher 100, to mix moist air from the tub 110 with indoor air, and discharge the mixed air to the indoor space during the drying cycle.

Specifically, the condenser 200 is located at the front of the door liner 121 (in FIG. 3), and is protected by the door cover 124.

Also, the condenser 200 includes a mixing device 210 for mixing suctioned moist air from the tub 110 with indoor air, and an exhaust duct 230 for exhausting the air mixed by the mixing device 210 to the indoor space.

Furthermore, an absorbing member 128 for allowing air mixture to seep through is installed at the lower end of the exhaust duct 230. The absorbing member 128 is supported on a bracket 129 connecting both sides of the front of the door liner 121. Here, the absorbing member 128 may be a porous material such as a sponge.

In further detail, in the drying cycle, the air in the tub 110 is in a hot and moist state, and the indoor air is in a cool and dry state. The hot and moist air is suctioned by the mixing device 210 and is mixed with the cool and dry indoor air to be converted into a mixture with a low level of moisture. The mixed air is then exhausted to the indoor space through the exhaust duct 230.

Accordingly, the hot, moist air inside the tub 110 meets cool, dry indoor air inside the mixing device 210, is converted to a mixture with a low temperature and level of moisture, and is exhausted to the indoor space, in order to prevent damage to a user by discharging hot, moist air at the user.

Also, a portion of the mixed air that flows through the exhaust duct 230 is condensed to condensed water. The condensed water flows into the tub 110, and the mixed air passes through the absorbing member 128 and is discharged through the lower end of the door 120.

Although not shown, a predetermined gap is formed in the door 120 with the door liner 121 and the door cover 124 in a coupled state, so that the mixed air is exhausted to the outside of the door 120 through the gap.

Here, the mixed air exhausted through the lower end of the door 120 has a low level of moisture, and therefore does not condense when it contacts indoor air.

Accordingly, the hot, moist air mixes with dry indoor air to become cool and dry, so that when it is exhausted to the indoor space, it will not condense into puddles on the floor.

The structure of the condenser 200 will be described in detail below.

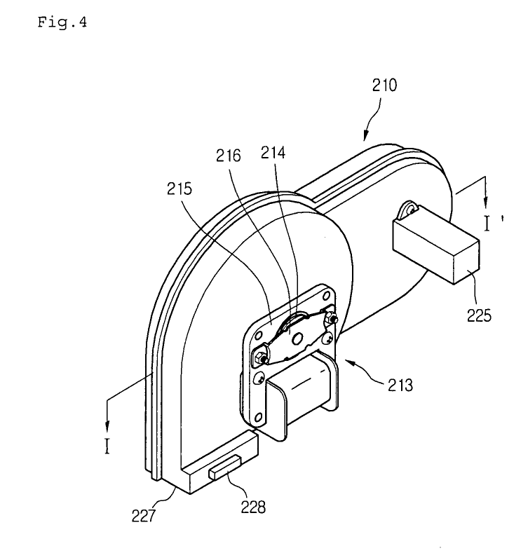

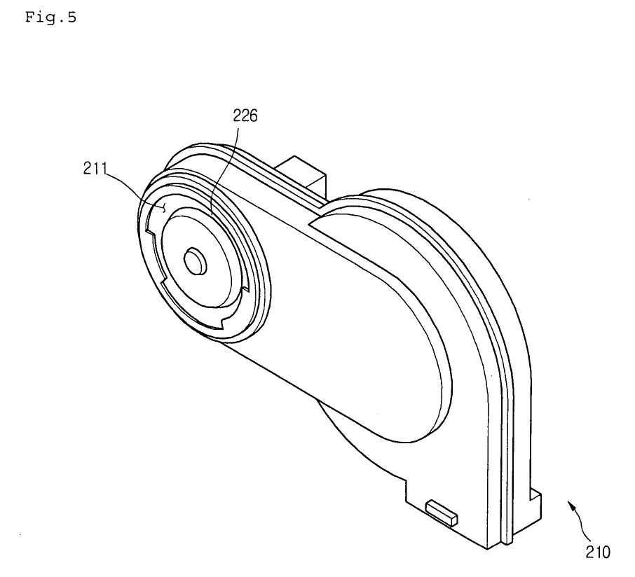

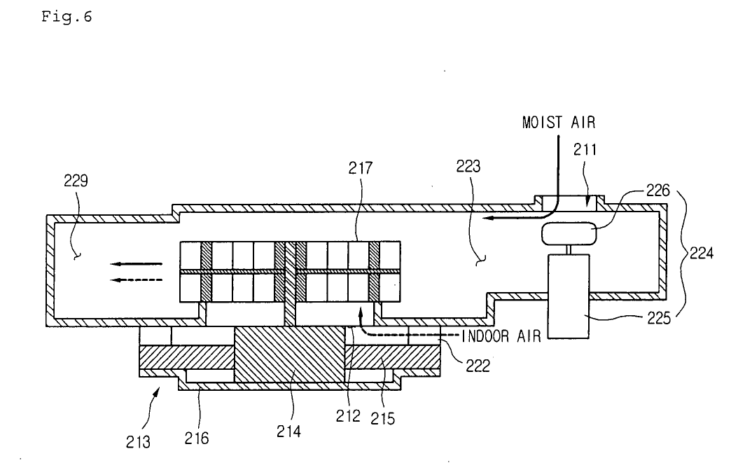

FIG. 4 is a frontal perspective view of a mixing device included in a condenser, FIG. 5 is a rear perspective view of the mixing device in FIG. 4, and FIG. 6 is a sectional view of the mixing device in FIG. 4 taken along line I-I′.

Here, the “front” of the mixing device is described in correlation with the front of the dishwasher.

Referring to FIGS. 4 through 6, a mixing device 210 according to the present embodiment includes a moist air intake 211 formed on the door liner 121 and communicating with the moist air inlet 127, an indoor air intake 212 that suctions indoor air flowing into the door 120 through the indoor air inlet 126, a single intake fan 217 for forcibly suctioning indoor air and moist air through the indoor air intake 212 and the moist air intake 211, and a motor assembly 213 for driving the intake fan 217.

The mixing device 210 also includes a sealing unit 224 to selectively open and close the moist air intake 211, and a mixed air exhaust port 227 that exhausts air mixed in the mixing device 210.

In detail, the moist air intake 211 is selectively opened during the drying cycle by the sealing unit 224.

Also, the sealing unit 224 includes a sealing member 226 for selectively sealing the moist air intake 211, and a driver 225 that moves the sealing member 226 back and forth.

Thus, during the drying cycle, the sealing member 226 is moved rearward by the driver 225 to open the moist air intake 211. When the drying cycle is completed, the sealing member 226 is moved forward by the driver 225 to seal the moist air intake 211.

Here, the sealing unit 224 may be formed with the sealing member 226 that moves rearward to open the moist air intake 211 (as described above), and alternately, a sealing plate may be provided at the bottom of the moist air intake 211 in a size corresponding to that of the moist air intake 211, and the sealing plate may be rotated by a rotating motor to selectively open and close the moist air intake 211.

Also, the sealing unit 224 may include a damper provided in an intake passage 223 of the mixing device 210, for selectively opening and closing the intake passage 223 by operating a driving motor that drives the damper.

The sealing unit 224 is not limited to the embodiments provided herein, and may have various structures for selectively opening and closing the intake passage 223.

The motor assembly 213 is coupled to a plurality of fastening ribs 222 formed to protrude a predetermined height from around the indoor air intake 212. That is, the motor assembly 213 is provided at the outer edge of the mixing device 210, and is installed a predetermined space apart from the indoor air intake 212.

Because the motor assembly 213 is installed a predetermined distance from the indoor air intake 212, indoor air entering the inside of the door 120 can be suctioned into the indoor air intake 212.

Also, the motor assembly 213 includes a drive motor 214 for driving the intake fan 217, a motor holder 215 on which the drive motor 214 is held, and a motor support 216 for supporting the drive motor 214.

When the intake fan 217 rotates, it not only suctions indoor air through the indoor air intake 212, but also suctions moist air from inside the tub through the moist air intake 211.

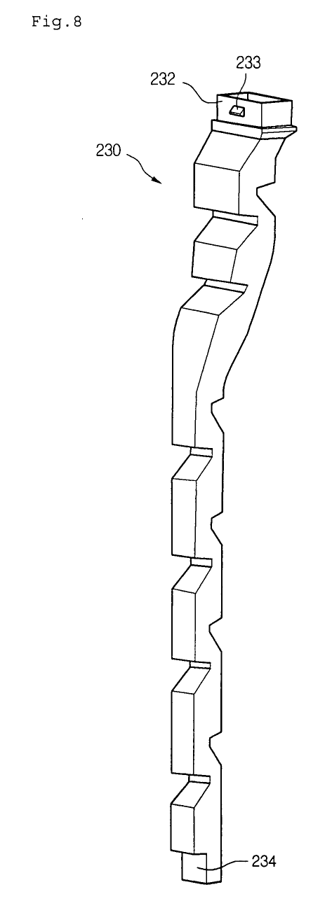

The mixed air exhaust port 227 has a catch receiver 228 for coupling to the exhaust duct 230 by receiving a catch 233 (in FIG. 8) on the exhaust duct 230.

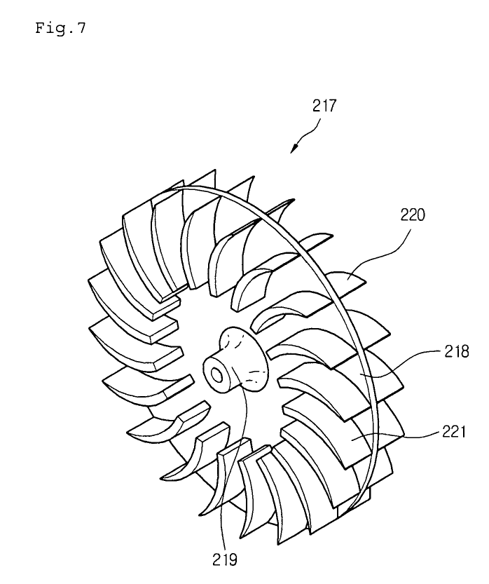

FIG. 7 is a perspective view of an intake fan included in the mixing device in FIG. 4.

Referring to FIGS. 6 and 7, an intake fan 217 of a mixing device 210 according to the present embodiment, as described above, suctions moist air from within the tub 110 and indoor air that has flowed into the door 120 into the mixing device at the same time.

Also, the intake fan 217 includes a rotating plate 218 in a center of which a motor shaft coupler 219 is formed, and a plurality of blades formed on either side of the rotating plate 218.

In detail, the blades are bent at a predetermined curvature, and are arranged around the edge of the rotating plate 218 with a predetermined distance therebetween. The blades include first blades 220 for suctioning moist air, and second blades 221 for suctioning indoor air.

The first blades 220 and the second blades 221 are formed facing each other with the rotating plate 218 in between, and have the same shape.

Therefore, because blades 220 and 221 are formed at either side of the intake fan 217, when the intake fan 217 rotates, moist air and indoor air are simultaneously suctioned into the mixing device 210.

Because the locations and the shapes of the first blades 220 and the second blades 221 are the same, the flow of both the indoor air and the moist air suctioned by the intake fan 217 are in the same direction, and the indoor and moist air are able to mix in a mixing space 229 of the mixing device 210.

That is, moist air and dry air that are suctioned through respectively different intakes first flows toward the axis of the intake fan 217, and then is discharged in a radial direction from the intake fan 217 to mix within the mixing space 229.

FIG. 8 is a perspective view of an exhaust duct included in the condenser.

Referring to FIG. 8, an exhaust duct 230 according to the present embodiment is formed in the shape of a meander line bent a plurality of times, as shown in FIG. 8, so that passage through which the mixed air flows within the exhaust duct 230 is lengthened.

Thus, as the mixed air flows through the inside of the exhaust duct 230, a portion of it is able to condense.

Also, the exhaust duct 230 includes an entrance 232 fastened to the mixing device 210 to admit mixed air discharged from the mixing device 210, and an exit 234 for discharging water that condenses during the process of the mixed air flowing through the inside of the exhaust duct and mixed air.

The entrance 232 also has the catch 233 formed thereon, for catching on the catch receiver 228 of the mixing device 210.

Below, a description will be given of a drying cycle of a dishwasher.

When the wash cycle and the rinse cycle of the dishwasher 100 are completed, the drying cycle is performed. Here, at the completion of the rinse cycle, the air inside the tub 110 is hot and moist.

Specifically, when the drying cycle begins, the sealing unit 224 opens the moist air intake 211. That is, the driver 225 moves the sealing member 226 rearward so that the moist air intake 211 is opened by the rearward movement of the sealing member 226.

Also, in concert with the operation of the sealing unit 224, the drive motor 214 also operates to rotate the intake fan 217. Specifically, when the intake fan 217 rotates, the moist air inside the tub 110 is suctioned into the mixing device 210 through the moist air inlet 127 and the moist air intake 211.

Simultaneously, indoor air is suctioned through the indoor air intake inlet 126 inside the door 120, and the indoor air that flows inside the door 120 is suctioned through the indoor air intake 212 into the mixing device 210.

Then, the suctioned moist air and indoor air are mixed within the mixing space 229, and the mixed air is exhausted through the mixed air exhaust port 227 and through the exhaust duct 230. Here, the suctioned hot and moist air cools and loses moisture as it mixes with the indoor air.

The mixed air exhausted through the exhaust duct 230 flows along the interior thereof, during which a portion of the air is condensed to water. Here, the condensed water is discharged from the exhaust duct 230 and flows into the tub 110, and the mixed air passes through the absorbing member 128 and is exhausted through the bottom of the door 120.

Here, the indoor air passes through the indoor air inlet 126 into the door, and flows through the indoor air intake 212 toward the mixing space 229. Therefore, it can be said that a passage for indoor air is formed within the door 120 according to the present embodiment. Also, the moist air inside the tub 110 passes through the moist air inlet 127 into the door, and then passes through the moist air intake 211 into the mixing space 229. Thus, it can be said that a passage for moist air is formed inside the door 120 according to the present embodiment. The mixed air flows along the exhaust duct and is expelled to the outside of the door. Thus, it can be said that a passage for discharging mixed air is formed inside the door 120 according to the present embodiment.

Then, after the drying cycle is complete, the intake fan 217 stops operating, and the sealing member 226 is moved forward by the driver 225 to seal the moist air intake 211.

As described, the mixing device 210 mixes moist air inside the tub 110 with indoor air to lower the temperature and moisture level of the moist air, and exhausts the mixture into the indoor space, so that damage to a user caused by exhausted air can be extensively prevented.

Also, water that is condensed inside the condenser is re-circulated to the inside of the tub, thus preventing condensing moisture from forming puddles on the floor of an indoor space.

Implementations of the dish washer are not limited to the above descriptions, and may include the following implementations.

First, the condenser, instead of having a separate mixing device and an exhaust duct, may have the two elements integrally formed. In this case, the condenser forms a moist air intake, an indoor air intake, and a mixed air exhaust port that are separated from each other.

Also, instead of having a single motor assembly and intake fan that auction the indoor air and moist air from the tub, the condenser may have a pair of intake fans and motor assemblies that respectively suction indoor air and moist air from within the tub through designated passages.

According to an alternate embodiment, the condenser may have two internal passages divided from one another, a fan provided for each passage, and a single motor assembly providing rotating force for each fan.

Additionally, instead of being provided in the door, the condenser may be provided at a different location outside the tub, in order to first mix moist air with indoor air and then exhaust the mixture to the outside.

What is claimed is:

1. A dish washer comprising:
a tub forming a wash compartment within;
a door for selectively opening and closing the tub, and defining an indoor air inlet in a side thereof and a moist air inlet in an inner surface thereof; and
a condenser provided within the door, for exhausting a mixture of indoor air and moist air suctioned into the door from the door, the moist air being from inside the tub.

2. The dish washer according to claim 1, wherein the condenser comprises:
a mixing device for mixing the indoor air with the moist air; and
an exhaust duct for exhausting the mixed indoor and moist air.

3. The dish washer according to claim 2, wherein the mixing device comprises:
an indoor air intake for suctioning the indoor air;
a moist air intake communicating with the moist air inlet, for suctioning the moist air from inside the tub; and
a fan-motor assembly for suctioning the indoor air and the moist air through the indoor air intake and the moist air intake.

4. The dish washer according to claim 3, wherein the fan-motor assembly comprises:
a single intake fan for suctioning the indoor air and the moist air simultaneously into the mixing device; and
a drive motor for driving the intake fan.

5. The dish washer according to claim 4, wherein the intake fan comprises:
a rotating plate coupled to a motor shaft of the drive motor; and
a plurality of blades formed on both sides of the rotating plate in corresponding shapes.

6. The dish washer according to claim 4, wherein the intake fan is provided within the mixing device, and the drive motor is connected to the intake fan from outside the mixing device.

7. The dish washer according to claim 3, wherein the mixing device further comprises a sealing unit for selectively opening and closing the moist air intake.

8. The dish washer according to claim 7, wherein the sealing unit opens the moist air intake when the fan-motor assembly operates, and closes the moist air intake when the fan-motor assembly does not operate.

9. The dish washer according to claim 7, wherein the sealing unit comprises:
a sealing member for moving forward and backward to selectively open and close the moist air intake; and
a driver for moving the sealing member.

10. The dish washer according to claim 2, wherein the exhaust duct is bent a plurality of times.

11. The dish washer according to claim 1, wherein the condenser comprises:
an indoor air intake for suctioning the indoor air,
a moist air intake for suctioning the moist air; and
a mixed air exhaust port for exhausting mixed air.

12. The dish washer according to claim 1, wherein the condenser comprises:
a moist air inlet into which moist air flows from within the tub; and
a sealing unit for selectively opening and closing the moist air inlet.

13. The dishwasher according to claim 1, wherein the mixture of indoor and moist air is exhausted through a lower end of the door.

14. A dish washer comprising:
a tub forming a wash compartment within; and
a condenser provided at a side of the tub, and including a moist air intake for suctioning moist air from within the tub, an outside air intake for suctioning air outside the tub, a mixing space for mixing the moist air with the outside air, and an exhaust passage for exhausting air from the mixing space to an outside.

15. The dish washer according to claim 14, wherein the condenser is provided within a door that selectively opens and closes the tub.

16. The dish washer according to claim 15, wherein the door defines a moist air inlet through which moist air from inside the tub enters, and an outside air inlet through which outside air enters.

17. The dish washer according to claim 14, wherein the condenser further comprises an intake fan and a motor assembly for simultaneously suctioning inside air and outside air through each of the intakes.

18. The dish washer according to claim 14, further comprising a sealing unit for selectively opening and closing the moist air intake.

19. A dish washer comprising:
a tub formed with an open side;
a door for selectively opening and closing the tub;
a moist air passage providing a passage for a flow of moist air from the tub into the door;
an indoor air passage providing a passage for a flow of indoor air into the door; and
a mixed air exhaust passage communicating with the moist air passage and the indoor air passage, for exhausting the moist air and the indoor air mixed within the door to an outside.

20. The dish washer according to claim 19, further comprising an intake fan and a motor assembly for suctioning the moist air and the indoor air respectively through the moist air passage and the indoor air passage.
